(19) United States
(12) Patent Application Publication
(10) Pub. No.: US 2026/0101147 A1
(43) Pub. Date: Apr. 9, 2026

(54) SYSTEM FOR OPERATING IN-CABIN LOUDSPEAKERS OF A VEHICLE

(71) Applicant: Harman Becker Automotive Systems, Inc., Novi, MI (US)

(72) Inventor: Prashanth KUNATI, Saroornagar (IN)

(21) Appl. No.: 18/908,035

(22) Filed: Oct. 7, 2024

(51) Int. Cl. H04R 29/00

(52) U.S. Cl. CPC H04R 29/002; H04R 2430/23; H04R 2499/13

(57) ABSTRACT

An audio system for a vehicle, the system includes a first loudspeaker of a plurality of loudspeakers configured to transmit a first audio test signal including at least one first audio property into a listening environment; one or more microphones configured to capture the first audio test signal; and at least one controller programmed to employ a beamforming operation to adjust a direction of the microphone toward the first loudspeaker; store information corresponding to at least one first predetermined audio property that is indicative of the first loudspeaker properly functioning; compare the at least one first audio property of the captured first audio test signal to the first predetermined audio property; and transmit a message indicative of the first loudspeaker exhibiting a failure based on the at least one first audio property not being similar to the first predetermined audio property.

### TECHNICAL FIELD

The present disclosure relates to a system and method for testing in-cabin loudspeakers of a vehicle and performing operations responsive to detecting a failure. These aspects and others will be discussed in more detail below.

### BACKGROUND

Modern vehicles may be provided with a plurality of loudspeakers to output audio sound inside a vehicle cabin. The plurality of loudspeakers may be located at various locations inside the vehicle cabin and configured as stereo loudspeakers. In some cases, one or more such loudspeakers may fail to output the desired sound due to various reasons such as, for example, a loudspeaker hardware failure, a wiring failure, an audio controller issue or the like.

### SUMMARY

In one or more exemplary embodiments of the present disclosure, an audio system for a vehicle, the system includes a first loudspeaker of a plurality of loudspeakers configured to transmit a first audio test signal including at least one first audio property into a listening environment; one or more microphones configured to capture the first audio test signal; and at least one controller programmed to employ a beamforming operation to adjust a direction of the microphone toward the first loudspeaker; store information corresponding to at least one first predetermined audio property that is indicative of the first loudspeaker properly functioning; compare the at least one first audio property of the captured first audio test signal to the first predetermined audio property; and transmit a message indicative of the first loudspeaker exhibiting a failure based on the at least one first audio property not being similar to the first predetermined audio property.

In one or more exemplary embodiments of the present disclosure, a method for a vehicle audio system includes transmitting into a listening environment, via a first loudspeaker of a plurality of loudspeakers, a first audio test signal including at least one first audio property; capturing, via at least one microphone, the first audio test signal; employing, via the at least one controller, a beamforming operation to adjust a direction of the microphone toward the first loudspeaker; storing, via the at least one controller, information corresponding to at least one first predetermined audio property that is indicative of the first loudspeaker properly functioning; comparing, via the at least one controller, the at least one first audio property of the captured first audio test signal to the first predetermined audio property; and transmitting, via the at least one controller, a message indicative of the first loudspeaker exhibiting a failure based on the at least one first audio property not being similar to the first predetermined audio property.

In one or more exemplary embodiments of the present disclosure, a non-transitory computer-readable medium includes instructions, when executed by at least one controller of an audio system, cause the audio system to receive a first audio test signal including at least one first audio property from a first loudspeaker of a plurality of loudspeakers; employ a beamforming operation to adjust a direction of the microphone toward the first loudspeaker; store information corresponding to at least one first predetermined audio property that is indicative of the first loudspeaker properly functioning; compare the at least one first audio property of the captured first audio test signal to the first predetermined audio property; and transmit a message indicative of the first loudspeaker exhibiting a failure based on the at least one first audio property not being similar to the first predetermined audio property.

### BRIEF DESCRIPTION OF THE DRAWINGS

For a better understanding of the invention and to show how it may be performed, embodiments thereof will now be described, by way of non-limiting example only, with reference to the accompanying drawings, in which:

FIG. 1 illustrates an example block topology of a vehicle system of one embodiment of the present disclosure.

FIG. 2 illustrates an example top view diagram of a vehicle cabin including a vehicle audio system of one embodiment of the present disclosure.

FIG. 3 illustrates an example flow diagram of a process for testing the audio system of one embodiment of the present disclosure.

FIG. 4 illustrates an example flow diagram of a process for testing the audio system of another embodiment of the present disclosure.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The present disclosure proposes, among other things, a system and method for testing in-cabin loudspeakers of a vehicle and adjusting operations of the loudspeakers responsive to detecting a failure.

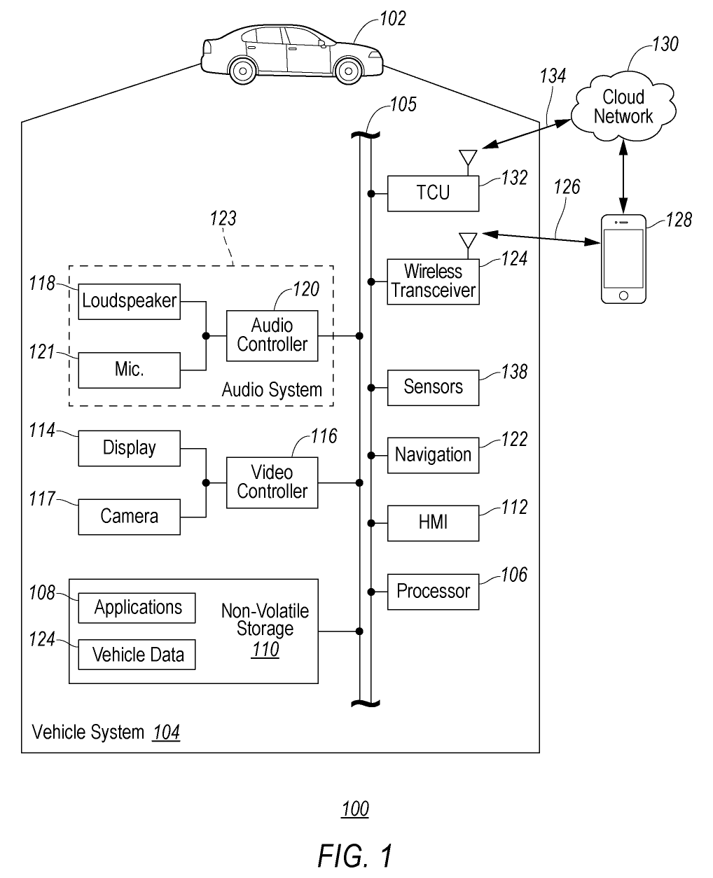

Referring to FIG. 1, an example block topology of a system 100 of one embodiment of the present disclosure is illustrated. A vehicle 102 may include various types of automobiles, crossover utility vehicle (CUV), sport utility vehicle (SUV), truck, recreational vehicle (RV), boat, plane, or other mobile machine for transporting people or goods. In many cases, the vehicle 102 may be powered by an engine. As another possibility, the vehicle 102 may be a battery electric vehicle (BEV), a hybrid electric vehicle (HEV) powered by both an internal combustion engine and one or move electric motors, such as a series hybrid electric vehicle (SHEV), a plug-in hybrid electric vehicle (PHEV), a parallel/series hybrid vehicle (PSHEV), or a fuel-cell electric vehicle (FCEV). It should be noted that the illustrated system 100 is merely an example, and more, fewer, and/or differently located elements may be used.

As illustrated in FIG. 1, the vehicle 102 may be provided with a vehicle system 104 including one or more processors 106 configured to perform instructions, commands, and other routines in support of the processes described herein. For instance, the vehicle system 104 may be configured to execute instructions of applications 108 to provide features such as vehicle operation controls, multimedia, or the like. Such instructions and other data may be maintained in a non-volatile manner using a variety of types of computer-readable storage medium 110. The computer-readable medium 110 (also referred to as a processor-readable medium or storage) includes any non-transitory medium that participates in providing instructions or other data that may be read by the processor 106 of the vehicle system 104. Computer-executable instructions may be compiled or interpreted from computer programs created using a variety of current and future programming languages and/or technologies.

The vehicle system 104 may be provided with one or more in-vehicle networks 105 configured to enable the communication between various components of the vehicle 102. The in-vehicle network 105 may be configured to support various communication protocol. For instance, the in-vehicle network 105 may be configured to support, but is not limited to, one or more of an I2C network, a controller area network (CAN), an Ethernet network, and a media-oriented system transport (MOST), as some examples. Furthermore, the in-vehicle network 105, or portions of the in-vehicle network 105, may be a wireless network accomplished via Bluetooth low-energy (BLE), Wi-Fi, or the like.

The vehicle system 104 may be provided with various features allowing the vehicle users to interface with the vehicle system 104. For example, the vehicle system 104 may receive input from human machine interface (HMI) controls 112 connected to the in-vehicle network 105 and configured to provide for user interaction with the vehicle 102. As an example, the vehicle system 104 may interface with one or more buttons, switches, knobs, touch screen or other HMI controls configured to invoke functions on the vehicle system 104 (e.g., navigation, audio/video playback, and etc.).

Any number of controllers (not shown) within the vehicle system 104 may also drive or otherwise communicate with one or more displays 114 configured to provide visual output to vehicle users by way of a video controller 116 through the in-vehicle network 105. In some cases, the display 114 may be a touch screen further configured to receive user touch input via the video controller 116, while in other cases the display 114 may be a display only, without touch input capabilities. In addition, any number of controllers of the vehicle system 104 may also drive or otherwise communicate with one or more cameras 117 configured to provide video input by way of the video controller 116 through the in-vehicle network 105. The cameras 117 may include one or more in-cabin camera configured to capture images within the cabin of the vehicle 102 such that the vehicle system 104 may determine the occupancy of the vehicle 102 (e.g., the number of users inside the vehicle cabin and the location of the users).

An audio controller 120 may also drive or otherwise communicate with one or more loudspeakers 118 configured to provide audio output to vehicle users . The audio controller 120 may be operable coupled with one or more microphones 121 to receive an audio input. The microphones 121 may employ beamforming technology and configured to focus on one or more specific sound sources to reduce background noise. For instance, the beamforming microphones 121 may focus on sound received from one or more directions and suppress sounds received from other directions. The audio controller 120 in combination with the loudspeakers 118 and the microphones 121 constitutes an audio system 123 of the vehicle 102.

The vehicle system 104 may also be provided with navigation and route planning features through a navigation controller 122 connected to the in-vehicle network 105 and configured to calculate navigation routes responsive to user input via e.g., the HMI controls 112, and output planned routes and instructions via the loudspeaker 118 and/or the display 114 through the audio controller 120 and/or the video controller 116. Location data that is needed for navigation may be determined by the communication with multiple satellites. Map data used for route planning may be stored in the storage 110 as a part of the vehicle data 125. Navigation software may be stored in the storage 110 as one of the vehicle applications 108.

The vehicle system 104 may also be provided with wireless communication capabilities via a wireless transceiver 124 connected to the in-vehicle network 105 and configured to wirelessly communicate with a mobile device 128 of vehicle users via a wireless connection 126. The mobile device 128 may be any of various types of portable computing devices, such as cellular phones, tablet computers, wearable devices, smart watches, smart fobs, laptop computers, portable music players, or other device capable of communication with the vehicle system 104. The wireless transceiver 126 may be configured to support a variety of wireless communication protocols including Wi-Fi, Bluetooth, radio-frequency identification (RFID), near-field communication (NFC), and communicate with a compatible wireless transceiver (not shown) of the mobile device 128 to enable various functions. For instance, the vehicle user may perform audio and/or video phone calls by mobile device 128 through the vehicle system 104. Additionally or alternatively, the vehicle system 104 may be configured to access a cloud network 130 via the mobile device 128 through wireless connection technologies such as cellular network.

The vehicle system 104 may also be provided with a telematics control unit (TCU) 132 connected to the in-vehicle network 105 and configured to control telecommunication between vehicle 102 and the cloud network 130 through a wireless connection 134 (e.g., using a modem) in addition to or in lieu of via the mobile device 128. For instance, the vehicle system 104 may download and/or upload data from/to the cloud network 130 via the TCU 132 or through the mobile device 128. It is noted that the term cloud network is used as a general term in the present disclosure and may include any computing network involving servers, carriers, routers, computers, controllers, circuitry or the like configured to store data and perform data processing functions and facilitate communication between various entities.

The vehicle system 104 may also be provided with one or more sensors 138 configured to measure various vehicle data. For instance, the sensors 138 may include one or more seat sensors configured to detect and determine the occupancy of the vehicle 102.

As described above, the vehicle system 104 may include a variety of components configured to perform different operations. Over time, one or more components may suffer from failures caused by various issues. For instance, the audio system 123 which includes the audio controller 120, the loudspeakers 118 and the microphones 121 may fail after prolong usage and the failure may be caused by wiring short/open circuits, loudspeaker hardware failure or the like. The failed audio system 123 may negatively affect the user experience. The present disclosure, among other things, proposes a system and method for detecting failures of the vehicle audio system 123 and perform operations to compensate for the failure.

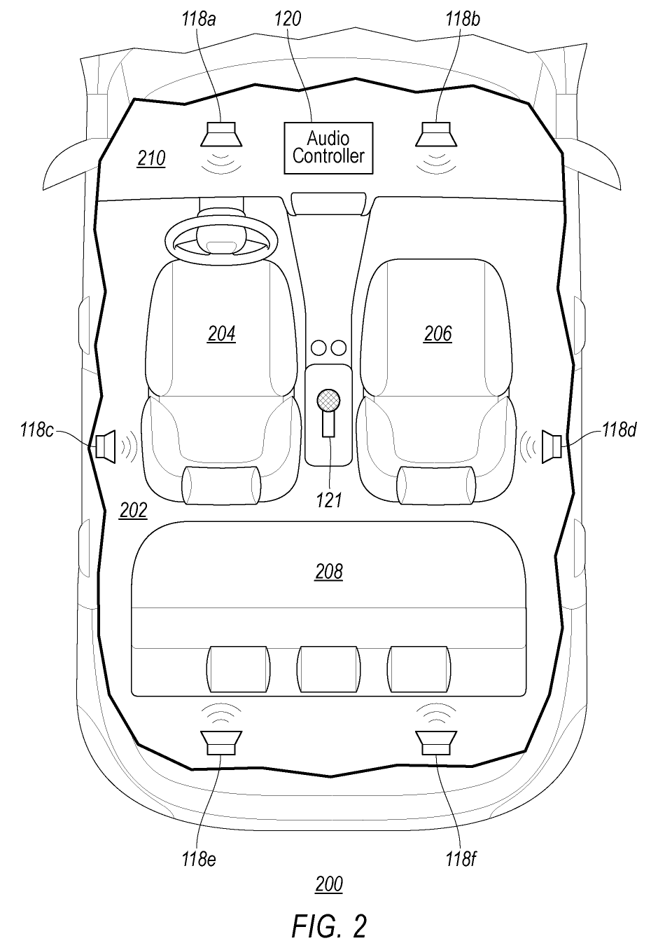

Referring to FIG. 2, an example top view diagram 200 of a vehicle cabin including a vehicle audio system of one embodiment of the present disclosure is illustrated. With continuing reference to FIG. 1, a vehicle cabin 202 of the vehicle 102 may include various components to perform various accommodations. For instance, a driver seat 204 may be located at the front-left side of the vehicle cabin 202 and configured to accommodate a vehicle driver. A passenger seat 206 may be located at the front-right side of the vehicle cabin 202 and configured to accommodate a vehicle passenger. A bench seat 208 (or rear seat 208) may be located at the back behind the driver seat 204 and the passenger seat 206 and configured to accommodate a plurality of vehicle users. Each of vehicle seat may be provided with one or more seat sensors 138 configured to detect the vehicle occupancy (e.g., how many users are in the vehicle cabin 202 and where do they seat at). The vehicle system 104 may adjust vehicle operations based on the vehicle occupancy. For instance, the audio controller 120 may be configured to adjust the audio output via the loudspeakers based on the vehicle occupancy.

As illustrated in FIG. 2, the vehicle 102 is provided with a plurality of loudspeakers 118 located at various locations of the vehicle cabin 202. More specifically, loudspeakers 118 may include a first loudspeaker 118a and a second loudspeaker 118b located at the front portion of the vehicle cabin 202. For instance, the first loudspeaker 118a and the second loudspeaker 118b may be located at and/or integrated with a vehicle dashboard 210 and orientated backward. The loudspeakers 118 may further include a third loudspeaker 118c and a fourth loudspeaker 118d located on the left and right sides of the vehicle cabin 202. For instance, the third loudspeaker 118c and fourth loudspeaker 118d may be located at and/or integrated with vehicle door panels and oriented inward. The loudspeakers 118 may further include a fifth loudspeaker 118e and a sixth loudspeaker 118f located at the back behind the rear seat 208. For instance, the fifth loudspeaker 118e and sixth loudspeaker 118f may be located at and/or integrated with the vehicle rear trim and oriented forward. The utilization of the plurality of loudspeakers 118 may provide the vehicle users with a stereo experience perceiving the audio sound from multiple directions.

Different loudspeakers 118 may be configured to support different output audio configurations. For instance, the loudspeakers may be generally configured to output audio sound in one or more audio frequency ranges/bands. More specifically, the frequency ranges may include a bass frequency range between 20 and 300 Hz, middle frequency range between 300 Hz to 4 kHz, and a treble frequency range from 4 kHz and above. Each loudspeaker 118 may be configured to output audio sound in one or more of the three frequency ranges. In the present example, the first loudspeaker 118a and the second loudspeaker 118b located in the front may be provided with hardware configured to support outputting audio sound within all of the three frequency ranges. The third loudspeaker 118c and the fourth loudspeaker 118d located on the two sides may be provided with hardware configured to support outputting audio sound within the treble frequency range and the middle frequency range, but not the base frequency range. The fifth loudspeaker 118e and the sixth loudspeaker 118f located behind the backseat 208 may be provided with hardware configured to support outputting audio sound within the middle frequency range and the base frequency range, but not the treble frequency range.

With continuing reference to FIG. 1, the vehicle system 104 may be further provided with one or more microphones 121 configured to receive audio input within the vehicle cabin 202. In the present example, the microphone may be provided at about the center of the vehicle cabin (e.g., mounted on the ceiling roof) and configured to collect audio input from various directions. The microphone 121 may be configured to support the beamforming technology to focus on the sound received from one or more directions. The beamforming direction may be dynamically adjusted by the audio controller 120 based on various conditions. The audio controllers 120 may adjust the beamforming direction of the microphone 121 based on the occupancy of the vehicle as detected via the seat sensors 138 and/or the camera 117. For instance, responsive to detecting the vehicle 102 is only driving by the driver on the driver seat 204 and there are no other passengers present in the vehicle cabin 202, the audio controller 120 may adjust the beamforming direction of the microphone 120 toward the driver seat 204 direction to the front-left to better capture the audio voice from the driver (e.g., during a hand-free phone call). In an alternative example, the vehicle system 104 may be configured to perform self-testing processes of the audio system 123 by analyzing the audio sound received by the microphone. The audio controller 120 may be configured to adjust the beamforming direction of the microphone to facilitate the testing process.

It is noted that although one microphone 121 and six loudspeakers 118 are present in the example illustrated with reference to FIG. 2, the present disclosure is not limited thereto. The vehicle cabin 202 may be provided with more or less loudspeakers 118 and/or microphones 121 depending on the configuration of the vehicle 102. For instance, more than one microphones 121 may be provided and configured to capture audio sounds from different directions and/or locations inside the vehicle cabin 202. Additionally, the plurality of loudspeakers 118 may be provided with frequency range configurations different from the example illustrated in FIG. 2 under essentially the same principle.

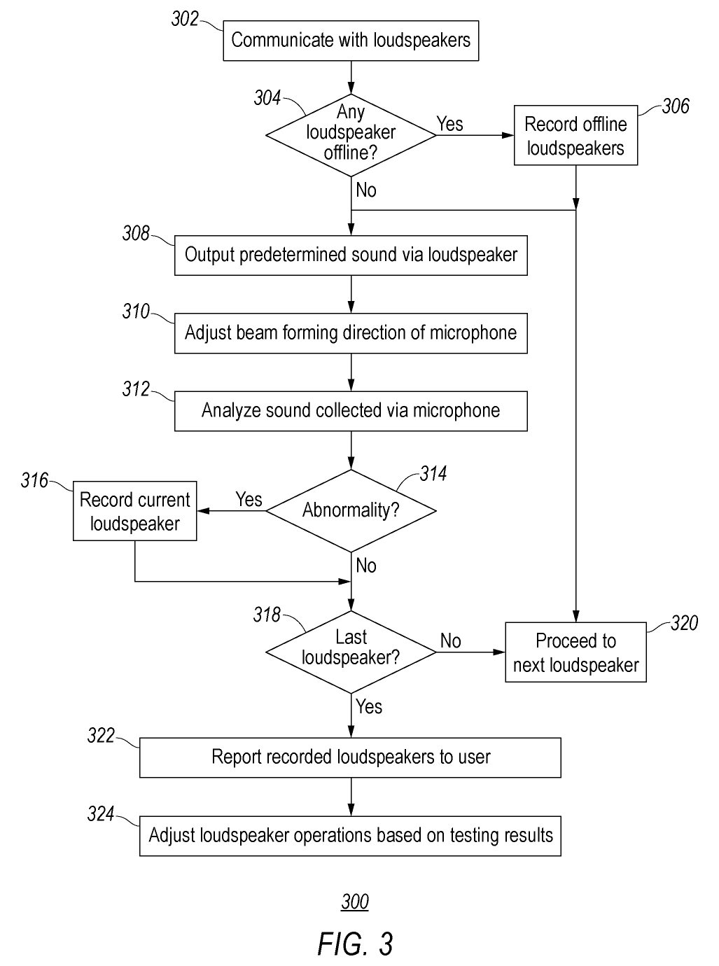

Referring to FIG. 3, an example flow diagram of a process 300 for testing the audio system of one embodiment of the present disclosure is illustrated. With continuing reference to FIGS. 1 and 2, the process 300 may be implemented via one or more components of the vehicle system 104. For instance, the process 300 may be primarily implemented via the audio system 123 of the vehicle system 104.

The testing process 300 starts at operation 302, and the audio controller 120 communicates with the plurality of loudspeakers 118 to determine if any of the loudspeakers 118 are offline and cannot be reached by the audio controller 120. Since the loudspeakers 118 and the audio controllers 120 may be connected via one or more cables, a communication failure therebetween may suggest a cable/wiring issue. The audio controller 120 may send a beacon signal to the loudspeakers 118 and expect a response from each of the receiving loudspeakers 118. If one or more of the receiving loudspeakers 118 fail to provide a response signal, the audio controller 120 may label the corresponding loudspeaker as being offline. Additionally or alternatively, the audio controller may send the DC and AC diagnostics signals and detect possible short/open circuits by observing the resistance/impedance of the cable.

At operation 304, if any of the loudspeakers 118 are offline, and/or any resistance/impedance abnormality is detected, the process proceeds to operation 306, and the audio controller 120 records the offline and/or abnormal loudspeaker. The recorded entry may include the identity of the loudspeakers as identified and the potential issue as detected such as not responding, high/low resistance/impedance or the like.

Otherwise, if all loudspeakers 118 are online and no abnormality is detected, the process proceeds to operation 308 from operation 304 to perform the sound test for each loudspeaker 118. In the present example, the sound testing process may be perform in a sequential manner with each speaking be testes at a time such that the sound output by the respective loudspeakers does not interfere with each other. Continuing with the example as illustrated with reference to FIG. 2, the audio controller 120 may start the sound testing from the first loudspeaker 118a, and then continues the sound test from the second loudspeaker 118b until the six loudspeaker 118f is tested. At operation 308, the audio controller 120 instructs the first loudspeaker 118a to output one or more predefined testing sounds for testing. The predefined testing sounds may include audio sounds within one or more frequency ranges supported by the respective loudspeaker. As discussed above, the first loudspeaker 118a may be configured to support the output of all of the three frequency ranges (e.g., treble, middle, and base frequencies). In this case, the predetermined testing sounds for the first loudspeaker may include a plurality of components to cover the testing for all the three frequency ranges. The audio controller 120 may output the components via the first loudspeaker 118a simultaneously to save time. Alternatively, the audio controller 120 may output the components of the testing sounds sequentially to reduce the interference (e.g., one component for each second).

In order to better capture the predetermined sounds, at operation 310, the audio controller 120 adjusts the beamforming direction of the microphone 121 toward the loudspeaker being tested such that the audio sound received from other directions is suppressed. The location and/or direction of each loudspeaker 118 as relative to the location of the microphone 121 is already known to the audio controller 120. In the present example, the audio controller 120 may adjust the beamforming direction of the microphone 121 toward the front-left aiming at the direction where the first loudspeaker 118a is located such that the microphone 121 captures the audio output by the first loudspeaker 118a.

At operation 312, the audio controller 120 analyzes the audio sounds captured by the microphone 121 to determine if the loudspeaker being tested is operating normally. Due to the operating condition for the vehicle 102, the captured sound may include noise (e.g., engine noise, wind noise, human speech) and thus the captured sound may not be exactly the same as the testing sound. However, due to the beamforming toward the loudspeaker being tested, the audio sound captured via the microphone 121 should be substantially the same as (or substantially resembles) the testing sound and include all the components of the predefined testing sound. The audio controller 120 may analyze the captured sound by comparing it with the predefined testing sound for the respective loudspeaker to determine if the captured sound include all of the components of the testing sound.

At operation 314, the audio controller 120 determines if any abnormality of the captured sounds is detected. The abnormality may include various situations indicative of potential hardware failures of the loudspeaker being tested. For instance, the audio controller 120 may flag an abnormality if one or more components and/or properties is missing from the captured sound indicative of the hardware associated with the missing component has failed. The audio controller 120 may also flag the abnormality responsive to detecting detected audio properties have deviated from the original corresponding properties more than a predefined threshold. For instance, the properties may include one or more predetermined audio frequencies. The deviated frequency may indicate a hardware failure.

If an abnormality is detected, the process proceeds to operation 316 and the audio controller 120 records the loudspeaker. Similar to operation 306, the recordation may include various entries associated with the loudspeaker being tested. The recorded entry may include the identity of the loudspeakers at issue and the information associated with the abnormality (e.g., missing components, deviating frequency).

At operation 308, the audio controller verifies if all of the online loudspeakers have been tested. If the answer is no, the process proceeds to operation 320 to proceeds to the next loudspeaker. The process returns to operation 308 to test the next loudspeaker under the process as described above.

If all loudspeakers have been tested, the proceeds from operation 318 to operation 322 and the vehicle system 104 reports the testing results to the vehicle user. The are a plurality of methods to report the test results to the user. For instance, the vehicle system 104 may output a message via the video controller 116 and/or the HMI controls 112. Additionally or alternatively, the vehicle system 104 may send a message to the mobile device 128 associated with the user via the wireless transceiver 124. Additionally or alternatively, the vehicle system 104 may report the testing results to the could network (e.g., to a server).

At operation 324, the audio controller 120 adjusts the operations of one or more loudspeakers 118 based on the testing results to compensate for the failure. Depending on the specific failure detected, operations of the remaining operating loudspeakers may be adjusted such that the failure may be compensated (at least partially). Continuing with the example illustrated with reference to FIG. 2, if the testing results are indicative of the sixth loudspeaker 118f experiencing a malfunction with the base frequency range (e.g., cannot output sound in base frequency range), the audio controller 120 may adjust other loudspeakers in support of the base frequency range to compensate for the failure of the six loudspeaker 118f. In this example, the audio controller 120 may increase the base frequency volume of the rest three loudspeakers (e.g., the first loudspeaker 118a, the second loudspeaker 118b, and the fifth loudspeaker 118e) in support of the base frequency range such that the user experience is not significantly affected.

Additionally, the audio controller 120 may further take into account the vehicle occupancy as measured via the seat sensors 138 and/or camera 117 in adjusting the operations of the loudspeaker operations. Continuing with the above example in which the base frequency range of the six loudspeaker 118f on the rear-right side is malfunctioning, if the vehicle systems 104 detects the driver is operating the vehicle alone on the driver seat 204 and no other passengers are present in the vehicle cabin 202, the audio controller 120 may refrain from increasing the base volume on the remaining three loudspeakers because malfunctioning loudspeaker 118f is far away from the driver seat and may not affect the driver’s audio experience significantly.

It is noted that although the present disclosure is discussed above with reference to a context of a vehicle, the present disclosure is not limited thereto and may be applied to various other scenarios utilizing multiple loudspeakers under essentially the same concept. For instance, the present disclosure may be utilized to a home theater, an office / conference room where multiple loudspeakers are present and their positions are known.

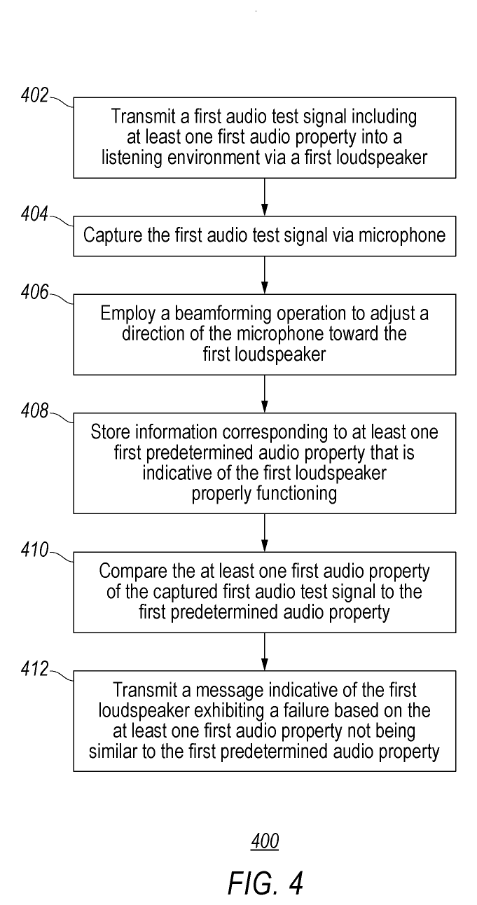

Referring to FIG. 4, an example flow diagram of a process 400 for testing the audio system of another embodiment of the present disclosure is illustrated. With continuing reference to FIGS. 1-3, the operations of the process 400 may be implemented via various components of the vehicle system 104.

At operation 402, a first loudspeaker 118a of a plurality of loudspeakers 118 transmits a first audio test signal including at least one first audio property into a listening environment. The listening environment may be the vehicle cabin in the present example. The first audio property may include at least one audio frequency.

At operation 404, a microphone 121 captures the first audio test signal transmitted via the first loudspeaker 118a.

At operation 406, at least one controller of the vehicle system 104 employs a beamforming operation to adjust a direction of the microphone 121 toward the first loudspeaker 118a. In one example, the beamforming operation may be employed to adjust the direction of the microphone 121 toward the first loudspeaker prior to the first loudspeaker 118a transmitting the first audio test signal into the listening environment.

At operation 408, the at least one controller of the vehicle system 104 stores information corresponding to at least one first predetermined audio property that is indicative of the first loudspeaker properly functioning. The information may be stored in the storage 110 as a part of the vehicle data. The at least one first predetermined audio property may include at least one audio frequency.

At operation 410, the at least one controller of the vehicle system 104 compares the at least one first audio property of the captured first audio test signal to the first predetermined audio property.

At operation 412, the at least one controller of the vehicle system 104 transmits a message indicative of the first loudspeaker 118a exhibiting a failure based on the at least one first audio property not being similar to the first predetermined audio property. For instance, if the frequency difference between the at least one first audio property and the first predetermined audio property is greater than a predefined threshold, a failure may be detected.

It is recognized that the controllers as disclosed herein may include various microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, such controllers as disclosed utilizes one or more microprocessors to execute a computer-program that is embodied in a non-transitory computer readable medium that is programmed to perform any number of the functions as disclosed. Further, the controller(s) as provided herein includes a housing and the various number of microprocessors, integrated circuits, and memory devices ((e.g., FLASH, random access memory (RAM), read only memory (ROM), electrically programmable read only memory (EPROM), electrically erasable programmable read only memory (EEPROM)) positioned within the housing. The controller(s) as disclosed also include hardware-based inputs and outputs for receiving and transmitting data, respectively from and to other hardware-based devices as discussed herein.

While exemplary embodiments are described above, it is not intended that these embodiments describe all possible forms encompassed by the claims. The words used in the specification are words of description rather than limitation, and it is understood that various changes may be made without departing from the spirit and scope of the disclosure. The words processor and processors may be interchanged herein, as may the words controller and controllers.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. An audio system for a vehicle, the system comprising:
a first loudspeaker of a plurality of loudspeakers configured to transmit a first audio test signal including at least one first audio property into a listening environment;
one or more microphones configured to capture the first audio test signal; and
at least one controller programmed to:
employ a beamforming operation to adjust a direction of the microphone toward the first loudspeaker;
store information corresponding to at least one first predetermined audio property that is indicative of the first loudspeaker properly functioning;
compare the at least one first audio property of the captured first audio test signal to the first predetermined audio property; and
transmit a message indicative of the first loudspeaker exhibiting a failure based on the at least one first audio property not being similar to the first predetermined audio property.

2. The audio system of claim 1, wherein the at least one controller is further programmed to control the first loudspeaker to transmit the first audio test signal.

3. The audio system of claim 1, wherein the at least one controller is further programmed to employ the beamforming operation to adjust the direction of the microphone toward the first loudspeaker prior to the first loudspeaker transmitting the first audio test signal into the listening environment.

4. The audio system of claim 1, wherein the first audio property includes an audio frequency.

5. The audio system of claim 1, wherein the at least one controller is further programmed to:
responsive to detecting the failure, adjust an operation of at least another loudspeaker of the plurality of loudspeakers to compensate for the failure.

6. The audio system of claim 1, further comprising a second loudspeaker of the plurality of loudspeakers configured to transmit a second audio test signal including at least one second audio property into the listening environment, wherein the second audio property is different from the first audio property.

7. The audio system of claim 1, wherein the at least one controller is further programmed to:
attempt to communicate with the plurality of loudspeakers; and
responsive to failing to receive a response from a second loudspeaker of the plurality of loudspeakers, identify the second loudspeaker as offline.

8. A method for a vehicle audio system, comprising:
transmitting into a listening environment, via a first loudspeaker of a plurality of loudspeakers, a first audio test signal including at least one first audio property;
capturing, via at least one microphone, the first audio test signal;
employing, via the at least one controller, a beamforming operation to adjust a direction of the microphone toward the first loudspeaker;
storing, via the at least one controller, information corresponding to at least one first predetermined audio property that is indicative of the first loudspeaker properly functioning;
comparing, via the at least one controller, the at least one first audio property of the captured first audio test signal to the first predetermined audio property; and
transmitting, via the at least one controller, a message indicative of the first loudspeaker exhibiting a failure based on the at least one first audio property not being similar to the first predetermined audio property.

9. The method of claim 8, further comprising:
controlling, via the at least one controller, the first loudspeaker to transmit the first audio test signal.

10. The method of claim 8, further comprising:
employing, via the at least one controller, the beamforming operation to adjust the direction of the microphone toward the first loudspeaker prior to the first loudspeaker transmitting the first audio test signal into the listening environment.

11. The method of claim 8, wherein the first audio property includes an audio frequency.

12. The method of claim 8, further comprising:
responsive to detecting the failure, adjusting, via the at least one controller, an operation of at least another loudspeaker of the plurality of loudspeakers to compensate for the failure.

13. The method of claim 8, further comprising:
transmitting into the listening environment, via a second loudspeaker of the plurality of loudspeakers, a second audio test signal including at least one second audio property, wherein the second audio property is different from the first audio property.

14. The method of claim 8, further comprising:
attempting, via the at least one controller, to communicate with the plurality of loudspeakers; and
responsive to failing to receive a response from a second loudspeaker of the plurality of loudspeakers, identifying, via the at least one controller, the second loudspeaker as offline.

15. A non-transitory computer-readable medium, comprising instructions, when executed by at least one controller of an audio system, cause the audio system to:
receive a first audio test signal including at least one first audio property from a first loudspeaker of a plurality of loudspeakers;
employ a beamforming operation to adjust a direction of the microphone toward the first loudspeaker;
store information corresponding to at least one first predetermined audio property that is indicative of the first loudspeaker properly functioning;
compare the at least one first audio property of the captured first audio test signal to the first predetermined audio property; and
transmit a message indicative of the first loudspeaker exhibiting a failure based on the at least one first audio property not being similar to the first predetermined audio property.

16. The non-transitory computer-readable medium of claim 15, further comprising instructions to cause the audio system to:
control, via the at least one controller, the first loudspeaker to transmit the first audio test signal.

17. The non-transitory computer-readable medium of claim 15, further comprising instructions to:
employ the beamforming operation to adjust the direction of the microphone toward the first loudspeaker prior to the first loudspeaker transmitting the first audio test signal into the listening environment.

18. The non-transitory computer-readable medium of claim 15, further comprising instructions to:
responsive to detecting the failure, adjust an operation of at least another loudspeaker of the plurality of loudspeakers to compensate for the failure.

19. The non-transitory computer-readable medium of claim 15, further comprising instructions to:
cause a second loudspeaker of the plurality of loudspeakers to transmit a second audio test signal including at least one second audio property, wherein the second audio property is different from the first audio property.

20. The non-transitory computer-readable medium of claim 15, further comprising instructions to:
attempt to communicate with the plurality of loudspeakers; and
responsive to failing to receive a response from a second loudspeaker of the plurality of loudspeakers, identify the second loudspeaker as offline.
